(19) United States
(12) Patent Application Publication
(10) Pub. No.: US 2018/0270084 A1
(43) Pub. Date: Sep. 20, 2018

(54) TECHNIQUE FOR EXCHANGING DATAGRAMS BETWEEN APPLICATION MODULES

(71) Applicant: Telefonaktiebolaget LM Ericsson (publ), Stockholm (SE)

(72) Inventors: Dénes György PÁZMÁNY, Aachen (DE); Khaled DARWISCH, Herzogenrath (DE); Karoly FARKAS, Herzogenrath (DE)

(21) Appl. No.: 15/756,655

(22) PCT Filed: Nov. 10, 2015
(86) PCT No.: PCT/EP2015/076230

§ 371 Date: Mar. 1, 2018

(51) Int. Cl. H04L 12/46; H04L 29/12; G06F 9/455

(52) U.S. Cl. CPC H04L 12/4633; H04L 12/4641; H04L 61/103; H04L 2212/00; H04L 61/6022; G06F 2009/45595; G06F 9/45558

(57) ABSTRACT

The present disclosure generally relates to the exchange of datagrams between application modules executed by machines connected to a telecommunications network. A method implementation of the technique presented herein comprises several steps performed or triggered by a first machine of the machines. The steps comprise executing one or more application modules, each of which being associated with an application module address and configured to exchange the datagrams using the associated application module address. The steps further comprise establishing a plurality of tunnels between the first machine and a plurality of second machines different from the first machine, each of the tunnels being associated with a tunnel endpoint address for one of the second machines. Still further, the steps comprise forwarding the datagrams between the application modules and tunnels depending on the application module address.

### TECHNICAL FIELD

The present disclosure generally relates to a technique for exchanging datagrams between application modules. More specifically, and without limitation, a method and a device are provided for exchanging datagrams between application modules executed by machines connected to a telecommunications network. Furthermore, a machine and a system thereof are provided.

### BACKGROUND

The Internet Protocol (IP) has become the predominating communication protocol inside telecommunications networks. However, the high complexity of the telecommunications networks and their network nodes, such as a Mobile-services Switching Center (MSC), a Home Subscriber Server (HSS), etc., is challenging for conventional IP technologies.

For example, if telecommunications network resources such as a data center are shared for different network functionalities, or even shared by different telecommunication operators, the data traffic may be separated by means of Virtual Local Area Networks (VLANs). However, an operator may be concerned with data security, if different network functionalities of different operators are switched through shared network elements.

Furthermore, the complex network nodes of a telecommunications network handle a wide diversity of signaling, data transfer and control protocols and are built from many application modules. These application modules are usually interconnected by means of a significant number of LANs or VLANs for the purpose of isolating different types of traffic, e.g. control traffic from data traffic, or internal signaling from external signaling. However, some operators may prefer not to disclose (e.g., in the context of the shared data center) a communication structure according to which the application modules that perform one of their network functionalities exchange data.

While it would be possible to increase data security by means of multipoint tunneling, such an existing technique would prevent an efficient communication between those application modules that have to exchange data. For example, existing techniques for multipoint tunneling would exclude selectively exchanging data between certain application modules.

### SUMMARY

Accordingly, there is a need for a technique that allows a telecommunication operator to define a network functionality using resources that also perform other network functionalities, e.g., for same or other operators.

As to one aspect, a method of exchanging datagrams between application modules executed by machines connected to a telecommunications network is provided. The method comprises the following steps performed or triggered by a first machine of the machines: a step of executing one or more application modules, each of which is associated with an application module address and configured to exchange the datagrams using the associated application module address; a step of establishing a plurality of tunnels between the first machine and a plurality of second machines different from the first machine, each of the tunnels being associated with a tunnel endpoint address for one of the second machines; and a step of forwarding the datagrams between the application modules and the tunnels depending on the application module address.

An operator using one or more of the machines may define a network functionality, e.g., by defining the application modules and/or a mapping between the application modules executed by the first machine and the corresponding tunnels towards other application modules executed by the second machines. Alternatively or in addition, the method may include automatically determining a mapping between tunnel endpoint address and application module address. The datagrams may be forwarded based on the mapping. E.g., datagrams may be forwarded in a first direction according to the mapping determined based on datagrams forwarded in a second direction opposite to the first direction.

At least some embodiments of the technique may selectively exchange the datagrams between certain application modules based on the application module address used in the forwarding step. The datagrams may be selectively exchanged, even though an underlying technique for point-to-point tunneling or multipoint tunneling is incapable of routing a carrier IP messages based on addressing information included in the tunneled message.

Implementation of the method may create a tunneled overlay-network. The tunneled overlay-network may also be referred to as an overlay tunnel network. E.g., the step of establishing the tunnels and the step of forwarding the datagrams may realize the tunneled overlay-network. The datagrams may be payload of data packets transported through the tunnels. The datagrams may also be referred to as tunneled messages and/or tunneled traffic. Each of the tunnels may be a point-to-point tunnel between the first machine and one of the second machines.

The application modules exchanging datagrams according to the establishing step and the forwarding step may bring about a network functionality, e.g., for the telecommunications network. The application modules exchanging datagrams may define a complex node. The application modules exchanging datagrams may perform a Virtual Network Function (VNF).

The tunnels may extend within an internal network, e.g., a portion of the telecommunications network. The internal network may be or may include a data network, e.g., internal to a data center and/or connecting a group of data centers.

The technique may emulate a multipoint tunneling mechanism. In particular, the step of forwarding may realize a multipoint tunneling mechanism. The tunneling mechanism may by-pass limitations of conventional techniques. The tunneled overlay-network may be a Layer 2 (L2) network using the tunneling mechanism for multipoint tunneling between the application modules.

At least one or each of the machines may be implemented by one or more physical or virtual machines (VMs). Application modules performed by one virtual machine may be collectively referred to as modules.

The tunneling mechanism may be capable of extending Local Area Networks (LANs) and Virtual LANs (VLANs) over an existing Internet Protocol (IP) network, e.g., the internal network. The tunneling mechanism may allow for applications inside the modules or the VMs to communicate with each other as if they were part of the same virtual or physical LAN.

The forwarding may also be referred to as switching. The technique may be implemented by adding a tunnel switching mechanism between the application modules and one or more networking interface of the machine.

The tunnel switching mechanism may be switching tunneled traffic via different point-to-point tunnels established according to the establishing step towards the second machines. The second machines may include other modules and/or other VMs. The switching may be performed automatically based on the application module address. The application module address may include an L2 address, e.g., a Medium Access Control (MAC) address. Alternatively or in addition, the application module address may include a VLAN tagging.

Alternatively or in addition, the application module address may include at least one of a Layer 3 (L3) address and a port number (e.g., an IP address and/or a port number, or an Internet socket). The IP address may be part of an IP subnet. Two or more IP subnets may share a VLAN-tagged L2 internal network. At least one of the L2 address, the L3 address, the VLAN-tagging and the IP subnets may be hidden (e.g., not visible or transparent) on the overlay tunnel network.

“Layers” may be defined according to a standardized protocol stack and/or the Open Systems Interconnection (OSI) reference model.

The endpoint addresses of the second machines may be detected and the tunnels may be established automatically, e.g., using standard IP protocols.

Implementations of the method may interconnect parts of multiple L2 networks (LAN/VLANs) that are spread around many VMs inside the data center, e.g., using a single overlay tunnel network.

The technique may support any upper layer protocol (e.g., a protocol of a layer higher than L2). A message according to the upper layer protocol may be encapsulated in a message, e.g., in an L2 message, inside the overlay tunnel network. The method may include fragmenting and/or defragmenting the encapsulated messages transported through the overlay tunnel network, e.g., according to a Maximum Transmission Unit (MTU).

The technique allows stand-alone implementations inside the machines (e.g., VMs) forming the VNF. The technique may be implemented independent of a type of the data center, independent of a software version used by the data center and/or agnostic to an internal network architecture of the data center.

The technique may reduce the effort for defining the VNF, e.g., the effort for a network configuration of the VNF at deployment in the data center. Configuring the overlay tunnel network according to the establishing step may reduce the effort. By way of example, the effort may be reduced by compatibility with IP address allocation mechanisms available in the data center. The technique permits securing the internal communication related to the VNF, e.g., by encrypting the traffic through the tunnels.

As to a further aspect, a computer program product is provided. The computer program product comprises program code portions for performing any one of the steps of the method aspects disclosed herein when the computer program product is executed by one or more computing devices. The computer program product may be stored on a computer-readable recording medium. The computer program product may also be provided for download via a network, e.g., the telecommunications network and/or the Internet.

As to another aspect, a device for exchanging datagrams between application modules executed by machines connected to a telecommunications network is provided. The device is configured to perform or trigger performing the following steps performed by a first machine of the machines: a step of executing one or more application modules, each of which is associated with an application module address and configured to exchange the datagrams using the associated application module address; a step of establishing a plurality of tunnels between the first machine and a plurality of second machines different from the first machine, each of the tunnels being associated with a tunnel endpoint address for one of the second machines; and a step of forwarding the datagrams between the application modules and the tunnels depending on the application module address.

As to a still further aspect, a machine for exchanging datagrams between application modules is provided. The machine is connected or connectable to a telecommunications network and comprises: an executing module for executing one or more application modules, each of which is associated with an application module address and configured to exchange the datagrams using the associated application module address; an establishing module for establishing a plurality of tunnels between the first machine and a plurality of second machines different from the first machine, each of the tunnels being associated with a tunnel endpoint address for one of the second machines; and a forwarding module for forwarding the datagrams between the application modules and the tunnels depending on the application module address.

The device, the machine and/or the system may further include any feature disclosed in the context of the method aspect. Particularly, any one of the modules, or a dedicated module or device unit, may be adapted to perform one or more of the steps of any method aspect.

Advantageous embodiments are specified by the dependent claims.

### BRIEF DESCRIPTION OF THE DRAWINGS

Further details of embodiments of the technique are described with reference to the enclosed drawings, wherein:

FIG. 1 schematically illustrates a machine for exchanging datagrams between application modules;

FIG. 2 shows a flowchart for a method of exchanging datagrams between application modules implementable at the machine of FIG. 1;

FIG. 3 schematically illustrates a first embodiment of the virtual machine of FIG. 1;

FIG. 4 schematically illustrates a second embodiment of the virtual machine of FIG. 1;

FIG. 5 schematically illustrates a complex node including multiple virtual machines;

FIG. 6 schematically illustrates a functional block diagram of the complex node of FIG. 5;

FIG. 7 shows a flowchart for an implementation of the method of FIG. 2;

FIG. 8 schematically illustrates a signaling sequence resulting from an implementation of the method of FIG. 2 or 7;

FIG. 9 schematically illustrates a device according to an embodiment of the invention; and

FIG. 10 schematically illustrates a machine according to an embodiment of the invention.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for fixed and mobile telecommunications networks, it is readily apparent that the technique described herein may be implemented in any network, e.g., a core network or a backhaul network of a telecommunications network. The technique may be implemented in any network that provides, directly or indirectly, wireless network access. The wireless access may be provided by an implementation according to the Global System for Mobile Communications (GSM), a Universal Mobile Telecommunications System (UMTS) implementation according to the 3rd Generation Partnership Project (3GPP), a 3GPP Long Term Evolution (LTE) implementation, Wireless Local Area Network (WLAN) according to the standard family IEEE 802.11 (e.g., IEEE 802.11a, g, n or ac) and/or a Worldwide Interoperability for Microwave Access (WiMAX) implementation according to the standard family IEEE 802.16.

Moreover, those skilled in the art will appreciate that the services, functions, steps and modules explained herein may be implemented using software functioning in conjunction with a physical and/or virtual machine. The physical and/or virtual machine may provide resources including a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods, devices and machines, the invention may also be embodied in a computer program product as well as in a system comprising a computer processor and memory coupled to the processor, wherein the memory is encoded with one or more programs that may perform the services, functions, steps and implement the modules disclosed herein.

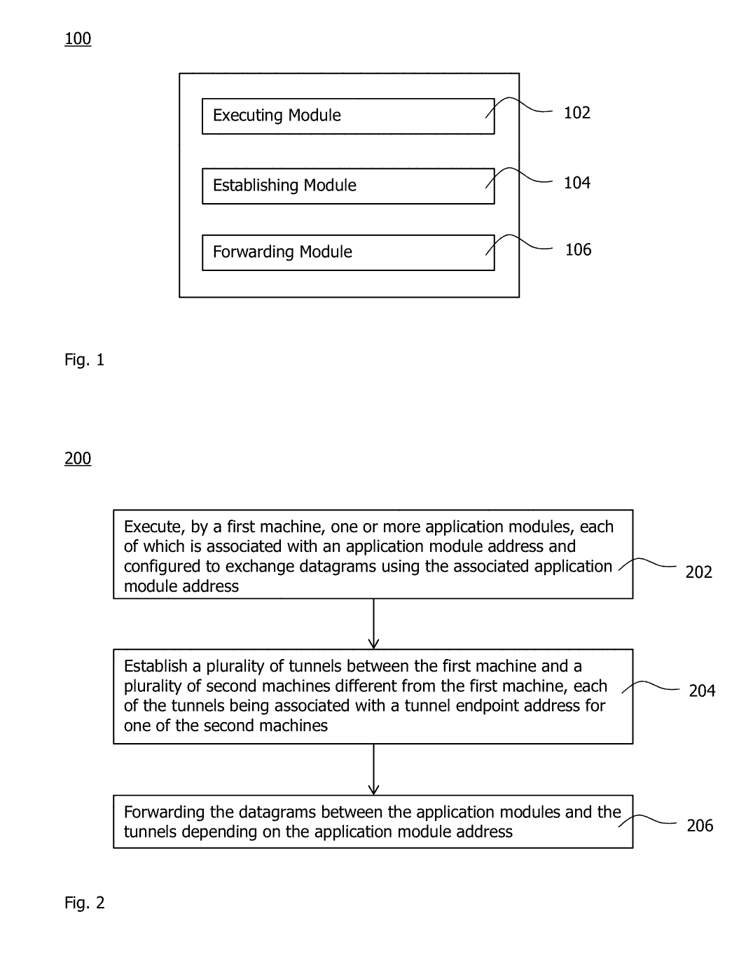

FIG. 1 schematically illustrates a first machine 100 for exchanging datagrams between application modules. The first machine 100 is connected or connectable to a telecommunications network. The first machine 100 comprises an executing module 102 for executing one or more application modules. Each application module is associated with an application module address and configured to exchange the datagrams using the associated application module address.

The first machine 100 further comprises an establishing module 104 for establishing a plurality of tunnels between the first machine 100 and a plurality of second machines different from the first machine. Each tunnel is associated with a tunnel endpoint address corresponding to one of the second machines. The first machine 100 further comprises a forwarding module 106 for forwarding the datagrams between the application modules and the tunnels depending on the application module address.

FIG. 2 shows a flowchart for a method 200 of exchanging datagrams between application modules. Machines connected to a telecommunications network execute the application modules. A first machine of the machines (e.g., the first machine 100) performs the method 200.

A device for exchanging datagrams between application modules executed by the machines may be connected to the telecommunications network. The device may be configured to perform or trigger performing the steps of the method 200. For example, the device may control the first machine to perform the method 200. The device may be included in each of the machines.

The method 200 includes a step 202 of executing one or more of the application modules. Each application module is associated with an application module address and exchanges its datagrams using the associated application module address. For example, the datagram may include an address field indicative of the application module address. Alternatively or in addition, a payload of data packets may include the datagrams. For example, the datagram may be included in a payload field of a data packet that further includes an address field indicative of the application module address.

In a step 204, a plurality of tunnels is established between the first machine and a plurality of second machines different from the first machine. Each of the tunnels is associated with a tunnel endpoint address that identifies one of the second machines. In a step 206 of the method 200, the datagrams are forwarded between the application modules and the tunnels depending on at least one of the application module address and the tunnel endpoint address.

For example, the datagram may be forwarded towards one of the application modules, which is determined based on the tunnel endpoint address. Alternatively or in addition, the datagram may be forwarded through one of the tunnels, which is determined based on the application module address. Those application modules that exchange datagrams through the tunnels may define one functional entity. The one functional entity may also be referred to as an application, a distributed application, a virtualized application, a complex application, a network function or a virtual network function (VNF).

The exchanging of the datagrams by the application module may include the step of sending the datagrams and/or receiving the datagrams, e.g., at the application module, the device and/or the first (e.g., virtual) machine 100. At least one or each of the second machines may be implemented by another embodiment of the first machine 100. The term “machines” may encompass both the first machine and the second machines.

Virtual or physical machines may implement the machines. At least one or each of the machines executing the application modules may be implemented by a virtual machine. For example, the first machine may be implemented by a first virtual machine. Alternatively or in addition, at least one or each of the plurality of second machines may be implemented by a second virtual machine. At least one or each of the virtual machines may be executed on one or more physical machines.

The first machine and/or the second machines may be connected to the telecommunications network (e.g., to a data network of a data center that is part of the telecommunications network). In the case of a physical machine, the connection may include a Network Interface Card (NIC). In the case of a virtual machine, the connection may be brought about by means of a virtual Network Interface Card (vNIC).

The attribute “virtual” may mean that a resource (e.g., a Network Interface Card or a machine) is provided by means of a combination of physical resources (e.g., a physical Network Interface Card or a physical machine) and an emulation module accessing the physical resource (e.g., a hypervisor). The first machine and/or each of the second machines may perform a separate operating system. Each machine (e.g., each virtual or physical machine) may provide at least one of a processor, a memory and interfaces, e.g., by means of emulation.

The method 200 may further comprise maintaining a table, e.g., at the first machine 100. The table may associate (or map) each of the application module addresses with one of the tunnel endpoint addresses, and/or vice versa. The datagrams may be forwarded by querying the table, e.g., based on the application module address.

The forwarding 206 may include a substep of forwarding a first datagram from one of the application modules to one of the tunnels. The forwarding 206 may further include a substep of forwarding a second datagram from the one tunnel to the one application module in response to the first datagram. Alternatively or as an example, the method 200 may comprise forwarding a resolution message for resolving network layer addresses into link layer addresses, and/or vice versa. The resolution message may include an Address Resolution Protocol (ARP) message and/or a Neighbor Discovery Protocol (NDP) message. The table may be updated based on the resolution message, e.g., a broadcast message and/or a response message.

Each of the plurality of second machines may be different from the first machine. The first machine and the second machines may be among the machines connected to the telecommunications network and executing the application modules. Those application modules that exchange datagrams may define a distributed application, e.g., a Virtual Network Function (VNF). The distributed application may be distributed between a plurality of machines. Those machines that exchange datagrams by means of the tunnels may define a node (e.g., a complex node) of the telecommunications network.

The forwarding may include transforming the datagrams between a first protocol (e.g., used by the plurality of application modules) and a second protocol (e.g., used by the plurality of tunnels). The second protocol may be a tunneling protocol, e.g., compatible with the telecommunications network.

The tunnels may be established according to the tunneling protocol. The tunnel endpoint address may be an address according to the tunneling protocol.

Those datagrams that are forwarded towards the tunnels may be encapsulated according to the tunneling protocol. Alternatively or in addition, those datagrams that are forwarded towards the one or more application modules may be extracted according to the tunneling protocol.

The application module address and the tunnel endpoint address may relate to different layers of a protocol stack used for the exchanging of the datagrams. The application module address may include a Layer 2 (L2) address or a Medium Access Control (MAC) address. The datagrams may include L2 frames or Ethernet frames. At least some of the application module addresses may include a Virtual Local Area Network (VLAN) tag, e.g., according to IEEE 802.1Q.

The tunnel endpoint address may include a Layer 3 (L3) address or an Internet Protocol (IP) address. The tunnels may be established and/or the datagrams may be forwarded according to the tunneling protocol. The tunneling protocol may be an L3 protocol, e.g., the Internet Protocol.

The application module address may uniquely identify the associated application module, e.g., locally at the first machine, or among the first machine and the plurality of second machines participating in performing the VNF. Alternatively or in addition, the application module address may include a local socket address. E.g., the application module address may include an IP address and/or a port number.

Each of the application modules executed by the first machine may be associated to an (e.g., physical or virtual) Ethernet port of the first machine. The application module address may include the L2 address of the associated Ethernet port.

A kernel of an operating system performed by the first machine may implement a plurality of L2 interfaces, e.g., for the vNIC. Each application module may be linked to one of the L2 interfaces. E.g., the virtual Ethernet ports may be implemented in the kernel of the operating system of the first machine. The application module address associated with the linked L2 interface may be the L2 address of the linked L2 interface.

The telecommunications network may include a data network within a data center. At least one of the first machine 100 and the second machines may be located in the data center. The first (e.g., virtual or physical) machine 100 and the second (e.g., virtual or physical) machines may be hosted within the data center. Alternatively or in addition, the telecommunications network may include a data network connecting a plurality of data centers. The first (virtual) machine 100 and the second (virtual) machine may be hosted by the plurality of data centers.

The forwarding 206 may include receiving or sending data packets through the tunnels. For example, the forwarding may include a substep of receiving data packets through the tunnels. The received data packets may include a source address field indicative of the tunnel endpoint address. The forwarding may further include a substep of extracting the datagrams from the received data packets. The extracted datagrams may include a destination address field indicative of the application module address. The forwarding may further include a substep of sending the extracted datagrams to the application module specified by the application module address.

Alternatively or in addition, the forwarding 206 may include a substep of obtaining the datagrams from the application modules. The obtained datagrams may include a source address field indicative of the application module address. The forwarding 206 may further include a substep of encapsulating the obtained datagrams in data packets including a destination address field indicative of the tunnel endpoint address depending on the application module address. The forwarding 206 may further include a substep of sending the data packets through the tunnel specified by the tunnel endpoint address.

Tunneling may be used (e.g., in an IP-based implementation of the data network or the telecommunications network) for securing the exchange of the datagrams along IP links passing through intermediate (e.g., not trustable) network segments and/or to isolate different types of traffic from each other. Tunneling may be also used to by-pass Network Address Translation (NAT) or firewalls.

Existing tunneling techniques are readily available in the data center. Existing tunneling techniques are described, inter alia, in documents US 2013/0311637 A1 and U.S. Pat. No. 8,213,429 B2. The tunnels may extend in the data center, e.g., between physical blades, between network segments belonging to the internal network spreading over multiple physical blades, between virtual switch instances running on different physical blades, etc.

For clarity, in what follows, the first machine 100 is described for a deployment of a VNF in a data center, while the technique is applicable for any complex node or VNF deployed in the telecommunications network, e.g. in one or more data centers. The deployment may use physical hardware directly, e.g., including NICs, or the deployment may use one or more virtual machines (VMs), e.g., including vNICs. Furthermore, the VMs composing the VNF may be substituted with modules of a complex node.

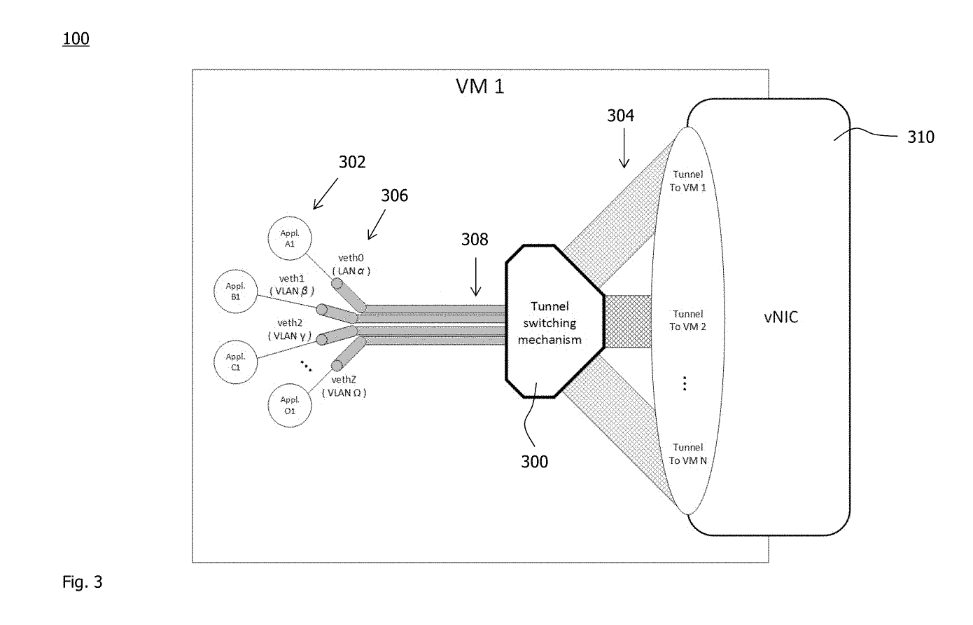

FIG. 3 schematically illustrates a first embodiment of the first machine 100. Each of the second machines may be implemented analogously to the first machine 100.

The first machine 100 is implemented by means of a VM (referred to as first VM). The first VM 100 stores and executes a plurality of application modules 302. For example, each application A may comprise a plurality of application modules Aⱼ executed on the j-th VM.

The method 200 may be implemented by the device 300. The device 300 may also be referred to as a tunnel switching mechanism (TSM). The device 300 may be arranged (e.g., in terms of a flow of the datagrams) between the application modules 302 running inside the VM 100 and the one or more vNICs 310 of the VM 100. For example, an implementation of the device 300 relays the flow of datagrams between the kernel of a Linux operating system running on the VM 100 and the vNIC 310.

FIG. 3 schematically illustrates an exemplary embodiment including one LAN and multiple VLANs, which are tunneled together through one vNIC 310 of the VM 100. The tunnels 304 are dynamically configured between the first VM 100 and each of the second VMs performing the VNF.

Each of the application modules 302 inside the VM 100 is connected to at least one virtual Ethernet interface (“veth”) 306. The virtual Ethernet interfaces may be implemented in the kernel of the operating system of the VM 100. Each of the virtual Ethernet interface represents an endpoints of a virtual link 308 corresponding to the LAN and VLANs. Each virtual Ethernet interface is associated with an MAC address and/or, in the case of VLAN link, with a specific VLAN tag.

In an embodiment, all application modules 302 are associated with a VLAN tag, except for only one of the application modules 302 that is untagged. In this case, the application module address may be the VLAN tag (which may be void or “Not A Number” for the untagged application module 302).

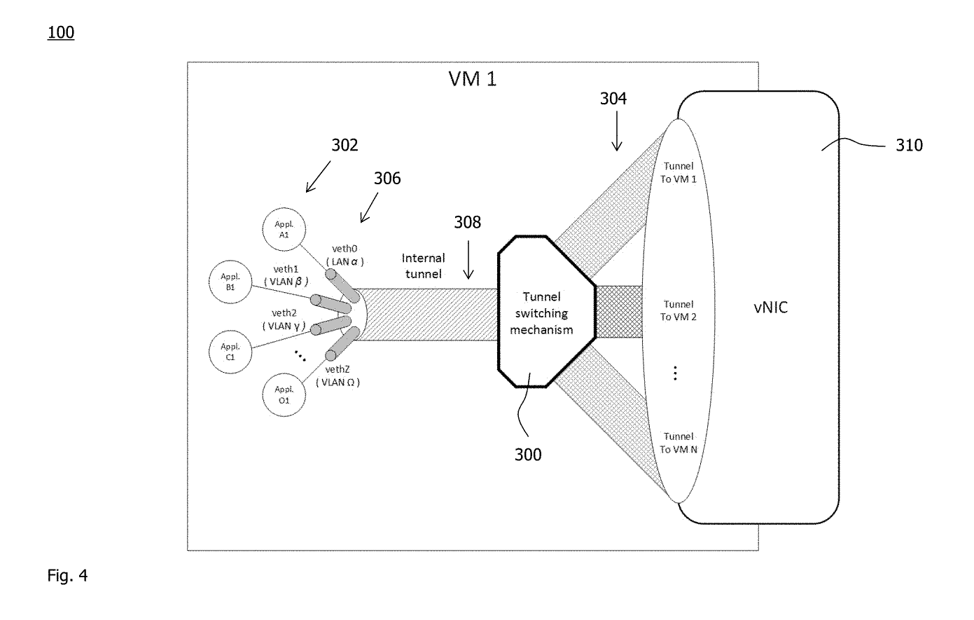

FIG. 4 schematically illustrates a second embodiment of the first machine 100. The datagrams from and/or to the application modules 302 are transported inside the first VM 100 through an internal tunnel inside each VM 100. These virtual links are transported inside the internal tunnel in the VM to a TSM instance.

An exemplary instance of the TSM 300 is connected to each of the one or more vNICs 310 of the VM 100. In the case of two or more vNICs 310, different vNICs 310 may be attached to different internal networks and/or IP subnets inside the data center. Otherwise, load sharing mechanisms between two or more vNICs 310 connected to the same internal IP network in the data center may be provided.

A tunnel endpoint (TE) of the tunnels 304 inside the data center is transparent for the application modules 302. The application modules 302 may determine the internal link endpoints 306, e.g., as the virtual Ethernet interface. Each of the application modules 302 may be associated with a MAC address and, optionally, an IP address of the associated interface as the application module address. If two or more application modules 302 are using the same LAN or VLAN network inside one VM 100, it is possible to differentiate between them by using dedicated ports or different IP addresses inside the same IP subnet as the application module address. In the second case, two or more IP addresses may be configured on the same virtual Ethernet interface 306.

In one implementation of the first machine 100, the application modules 302 are interchanging only IP protocol message payloads as the datagrams. Packing and/or unpacking of the IP payloads into and/or from L2 Ethernet frame-structured messages (and the optional VLAN tagging) is performed by the TSM 300 (e.g., in the embodiment of FIG. 3) or by the virtual Ethernet interfaces 306 (e.g., in the embodiment of FIG. 4).

The virtual Ethernet interfaces 306 are hidden from the internal IP network of the data center inside the tunnels 304. If convenient, the network interfaces 310 in the data center can keep their IP addresses from a previous node deployment in the telecommunications network (e.g., a previous deployment using hardware modules). No change of IP address allocation is caused or necessary when interconnecting the application modules 302 with application modules on the second machines inside the VNF.

In the first embodiment of the VM 100 (illustrated in FIG. 3), virtual Ethernet interfaces 306 are integrated parts of the TSM 300, as illustrated at reference sign 308 in FIG. 3. In the second embodiment of the VM 100 (illustrated in FIG. 4), one end of the internal tunnel 308 inside the VM 100 is implemented in the operating system of the VM 100, for example, in the kernel of the operating system running on the VM 100. By way of example, the internal tunnel 308 is implemented by means of a Linux bridge.

Both the first and second embodiments have specific advantages. In the second embodiment (e.g., if the VM 100 runs a Linux operating system), the presence of the internal tunnel 308 simplifies the structure of the TSM 300 and the creation of the TE outside of the TSM 300 can be achieved by configuring existing (e.g., Linux) kernel functions.

Alternatively or in addition, in the second embodiment with internal tunnel 308, the other end of the internal tunnel is attached to the TSM 300. Both VM-internal TEs may have reserved (e.g., private) IP addresses, which are used only for the purpose of the internal tunnel 308 and not visible outside of the VM 100.

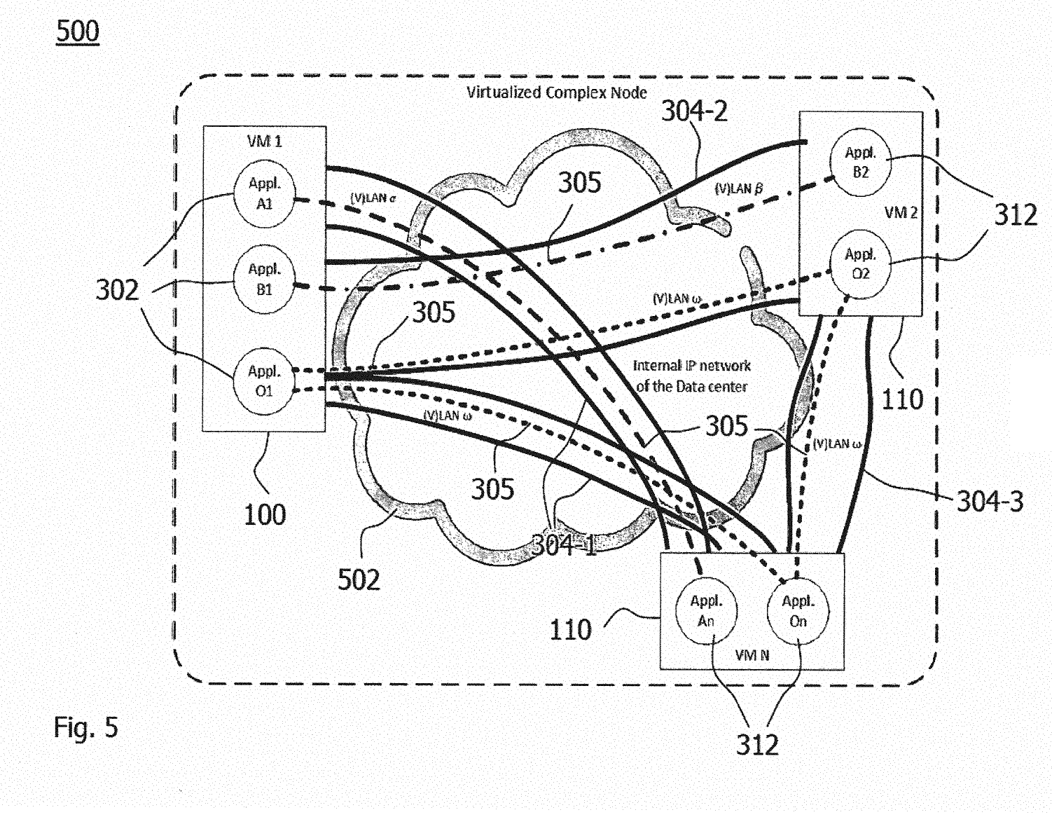

FIG. 5 schematically illustrates a system 500 comprising a plurality of the machines. One of the machines may be referred to as the first machine 100, and the other machines may be referred to as the second machines 110. As far as the technique is concerned, each of the machines 100 and 110 may perform the method 200, e.g., by including an instance of the device 300. That is, any other permutation of first and second machines may be applied to the system 500.

From a functional point of view, the system 500 defines one or more VNFs or complex nodes of the telecommunications network. A structure of the complex node is illustrated in FIG. 5. The complex node, i.e., the system 500, may be deployed in a data center. The telecommunication network includes a data network 502 in the data center. The internal network 502 may be kept unchanged as the complex node 500 is deployed.

The complex node 500 may be connected with (e.g., complex) nodes of other operators, e.g., via IP networks. Traffic of the same type, but originating from different operators, may have to be isolated from each other. E.g., Session Initiation Protocol (SIP) signaling from a Voice over IP (VoIP) operator has to be separated from SIP signaling from a telecom operator. As a consequence, a Layer 2 topology may include a significant number of node-internal (and, optionally, node-external) LANs and VLANs.

An exemplary way of forwarding the datagrams (e.g., on a LAN or on a VLAN) shown at reference sign 305 in FIG. 5 through an OSI Layer 3 network 502 (e.g., an IP network) uses Layer 2 tunneling. The Layer 2 links 305 terminate at the interfaces 306. For example, Ethernet may be used as the Layer 2 protocol. The tunneling mechanism achieved by an implementation of the technique may be capable of transferring both untagged datagrams (e.g., Layer 2 LAN messaging) and tagged datagrams (e.g., Layer 2 VLAN messaging).

At least one tunnel 304 is established in the step 204 between each pair of the machines 100 and 110 that execute application modules of the complex node 500. The application modules 312 are executed by the second machines 110 and exchange datagrams with the application modules 302 executed by the first machine 100.

Examples for the tunneling protocol include a Generic Routing Encapsulation (GRE) protocol, a Layer 2 Tunneling Protocol (L2TP), a Virtual Extensible Local Area Network (VxLAN) protocol, or a combination thereof. For example, the tunnels 304-1 and 304-2 may start at the first machine 100 and terminate at different ones of the second machines 110. Alternatively, more than one tunnel 304-2 may be established between the first machine 100 and the N-th second machine 110, as is schematically illustrated in FIG. 5. A tunnel 304-3 interconnects the second machines 110.

The technique may be implemented independent of the IP network 502 used to transfer the tunneled messages and/or independent of an IP subnet structure of the data center. Therefore, the technique may be deployed inside the (e.g., virtual) machines 100 and 110 composing the complex node 500. For example, the technique may be deployed inside modules composing the complex node. As a consequence, the technique and/or the resulting flow of datagrams may be in control of a service provider or telecommunications operator using the VNF or complex node 500.

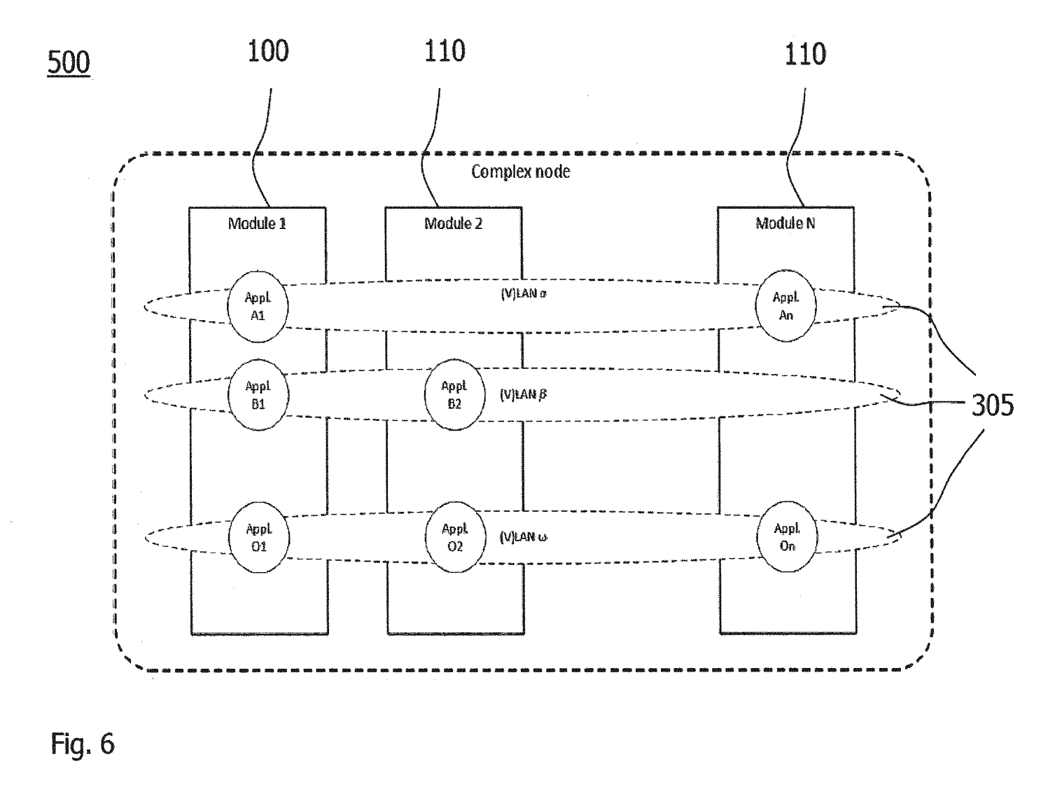

A functional structure of the complex node 500 is schematically illustrated in FIG. 6.

The complex node 500 may comprise a number of hardware modules or virtualized modules as the machines 100 and 110 labeled by j=1, 2, . . . , N. Each module hosts a number of application modules 302 labeled Aⱼ. The application modules 302, which are interacting with each other to implement the VNF of the complex node 500, are connected via node-internal OSI Layer 2 networks or links 305, e.g., LANs or VLANs. The number of modules or machines 100 and 110, application modules 302 and interconnecting links 305 can be arbitrary high.

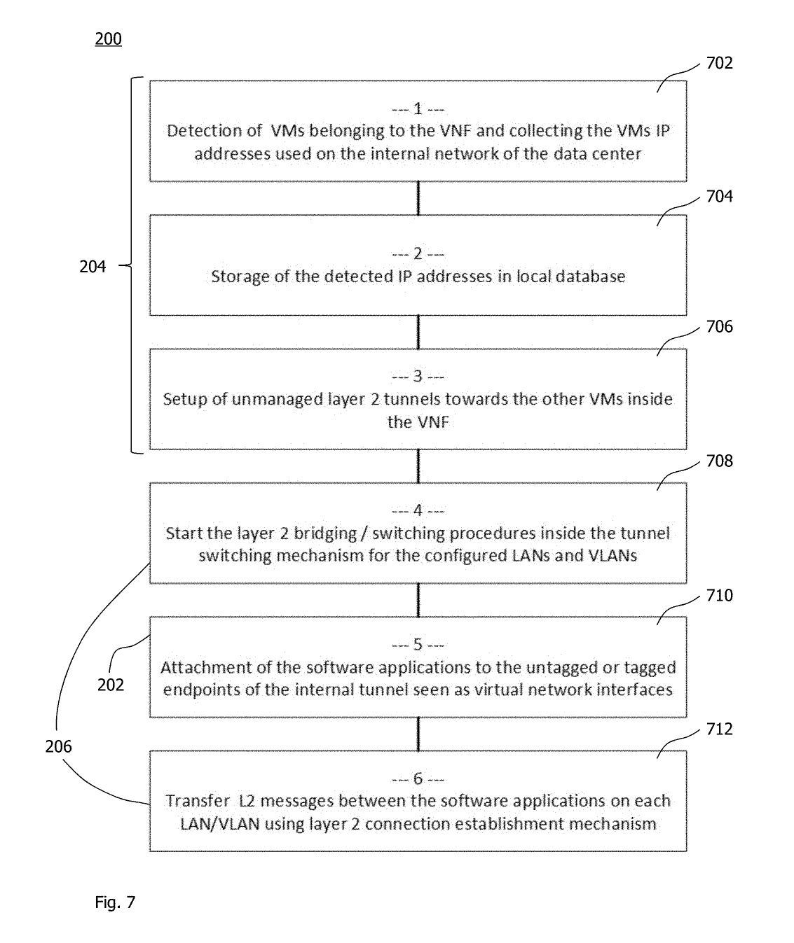

FIG. 7 shows a flowchart for an implementation of the method 200. In a substep 702 of the step 204, an instance of the TSM 300 uses IP protocol messages to detect the second VMs attached to the IP network 502 of the data center and belonging to the same VNF. The IP protocol messages are sent through the vNIC 310 to which the TSM 300 is connected and over the IP network 502 of the data center. The detected IP addresses of the second VMs 110 are stored in a local database (e.g., an Address Resolution Protocol table) in a substep 704 of the step 204. The database is updated also when a detection protocol message is received from one of the second VMs 110. In this way, a dynamic attachment of further second VMs 110 (or a release of one of the second VMs 110) to the VNF is automatically registered.

The technique, e.g., the substep 704, may comply with one or both of an IPv4 data network 502 and an IPv6 data network 502 in the data center by using adequate IP protocols for detection of the second VMs 110. For example, the Address Resolution Protocol (ARP) is used for IPv4 and/or the Neighbor Discovery Protocol (NDP) is used for IPv6. If both IP versions are available in the data center, the method 200 may use the IPv6 NDP. For clarity and not limitation, the IPv4 case using ARP messages is described in what follows.

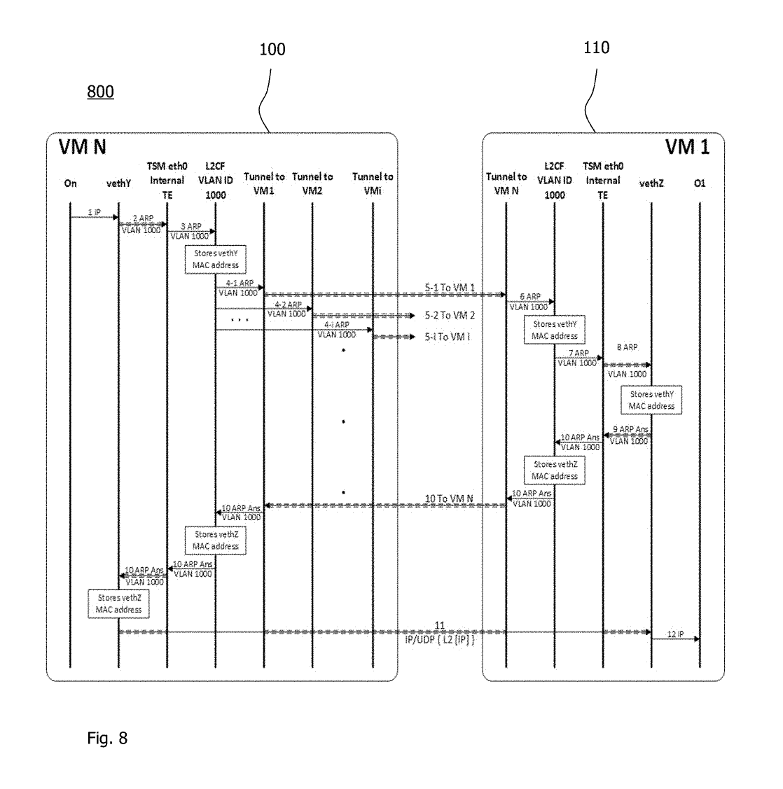

FIG. 8 schematically illustrates a signaling sequence 800 for detecting the tunnel endpoint addresses associated to the second VMs 110 according to the substep 702. The tunnel endpoint address may be the IP address of the respective second VM 110, e.g., the IP address of the vNIC at the respective second VM 110. The signaling sequence 800 may result from any of the above embodiments.

A gratuitous ARP message is sent by one of the virtual machines (e.g., the first VM 100, as illustrated, or one of the second virtual machines 110) upon connecting to the data network 502 of the data center at a step 1. The ARP message is indicative of the presence of the sending VM 100 and the IP address of its TE. Other VMs (e.g., the second VMs, as illustrated, or including the first VM 100) of the VNF or complex node 500 are already connected to the internal network 502 of the data center and store the IP address of the newly connected one VM 100. The other VMs 110 answer the gratuitous ARP message at step 9. Each ARP answer is indicative of the IP addresses of the answering TE, which addresses, in turn, is stored by the newly connected on VM 100 in step 10. Optionally, the TSM 300 runs checks at regular time intervals (e.g., equivalent to a heartbeat mechanism) to verify the consistency of the stored data.

Alternatively or in addition, the ARP answer may be indicative of a MAC address and/or an IP address for at least one or each of the second machines 110.

After detecting the IP addresses of the second VMs 110, the TSM 300 sets up a layer 2 tunnel starting from the IP address of the vNIC 310 (to which the TSM 300 is connected) towards each of the detected IP addresses on the second VMs 110 according to a substep 706 of the step 204. As a result, an overlay tunnel network 304 between the VMs 100 and 110 belonging to the VNF is dynamically configured.

From the perspective of the complex node 500, the overlay tunnel network 304 is fully meshed. In the case of multiple data network in the data center, such a full mesh overlay tunnel network 304 can be set up over each internal IP network of the data center to which VMs belonging to the VNF are attached by means of vNICs.

Such an automation of establishing the tunnels 304 in the step 204 facilitates the configuration of the VNF. Manually matching configuration data at each of the first and second machines 100 and 110, e.g., at the TEs on different VMs, may be avoided.

Inside the TSM 300, for each LAN and/or VLAN, a layer 2 connection function (L2CF) may be used. The L2CF is capable of forwarding ARP messages received from the application modules 302 (e.g., at the integrated interfaces 308 in the first embodiment or at the internal tunnel 308 in the second embodiment) towards all (or the relevant one) of the machine-external tunnels 304. Alternatively or in addition, the L2CF in the TSM 300 forwards the ARP messages received from the external tunnels 304 towards the application modules 302 (e.g., to the integrated interfaces 308 in the first embodiment or through the internal tunnel 308 in the second embodiment). For clarity and without limitation, the technique is described for the case of an internal tunnel (e.g., according to the second embodiment) in what follows.

Each of the internal tunnel 308 and the external tunnels 304 is connected to one port of the L2CF. The collected L2 address information is stored in the ARP table in association with the port to which the ARP answer was forwarded.

The TSM 300 is capable of handling all VLAN IDs (e.g., VLAN tags) used inside the VNF. For example, the TSM 300 executes an instance of the L2CF for each VLAN ID. The number of VLANs used inside a VNF and the allocated VLAN IDs is part of configuration data.

The VNF or complex node 500 may be connected via the telecommunications network with other VNFs and/or complex nodes. In an extension of any embodiment, the technique is applied to an external communication between VNFs or complex nodes. In this case, the configuration data is also coordinated with all other participants to allow exchanging of the datagrams.

In any embodiment, the configuration data and/or a package of executable instructions for deploying the TSM 300 is included in data images used in the data center for booting the first machine 100 and the second machines 110. E.g., an instance of the TSM 300 starts executing together with the application modules 302 of the VMs 100 and 110 at boot time.

It is sufficient to locally store the detected IP addresses of the second VMs 110 in the substep 704, for example in Random Access Memory (RAM), because of a volatile nature of the VMs 100 and 110 in the data center. Whenever any of the VMs 100 and 110 is restarted, the step 204 of the method 200 may be repeated, e.g., by restarting from the beginning of the flowchart in FIG. 7.

Once the substeps 702 and 704 have been completed, the tunnels 304 are established according to the step 204, e.g., according to the substep 706. For example, unmanaged tunnels 304 are used. The unmanaged tunnels 304 are established by configuring the IP addresses of the two or more other tunnel endpoint addresses (e.g., corresponding to the two or more tunnels 304-1 and 304-2 starting at the first machine 100). The tunnel endpoint addresses may be configured in the local endpoint of the first machine 100. To this end, the tunnel endpoint addresses are taken by the TSM 300 from the local database.

No IP addresses are defined for the LAN or VLAN virtual link endpoints 306 inside the TSM 300 (e.g., for the first embodiment shown in FIG. 3), as integrated link endpoints 306 are switched at layer 2. Inside the TSM 300, each Layer 2 network is identified by a VLAN ID or is untagged. The Layer 2 networks are handled independently from each other, e.g., by means of dedicated L2CFs.

The number and value of the VLAN IDs for which independent L2CFs have to be executed inside the TSM 300 may be part of the configuration data of the VNF, which is optionally stored inside the data images used for booting the VMs 100 and 110 in the data center. Thus, the VLANs are pre-configured and their number is available at boot time.

The technique is compatible with using two or more LANs in parallel. To this end, the machines 100 and 110 have more than one physical or virtual NIC 310. It is possible to set up untagged L2 traffic through each vNIC 310 by connecting different vNICs 310 to different internal IP networks 502 of the data center and assigning to the vNICs 310 IP addresses belonging to different IP subnets. In this case, one instance of the TSM 300 may be executed for each vNIC 310. The technique may also allow reusing the same VLAN IDs over different vNICs 310.

The step 206 may include the substeps 708 and 712 in FIG. 7. The step 202 may include attaching the application modules 302 (that are also referred to as software application) according to the substep 710.

The TSM 300 may perform at least the steps 204 and 206 of the method 200. The L2CF inside the TSM 300 may be established by using (e.g., Linux) kernel facilities, while the TSM 300 can be implemented as a stand-alone software application.

Setting up the complex node 500 for providing the VNF with NVMs, may include setting up N−1 tunnels 304 from each of the VMs towards each of the other N−1 VMs. If the VNF is deploying K VLANs plus 1 LAN over a (e.g., virtual) data center network 502, each TSM 300 connected to that (virtual) data center network 502 executes a maximum of K+1 instances of the L2CF. The exact number of L2CF instances is given by the number of LAN and/or VLANs used by the application modules 302 inside the first VM 100 executing said application modules 302.

The number of instances of the TSM 300 running in parallel inside any of the VMs is given by the number of virtual data center networks 502 used by the VNF. Each VM belonging to the VNF possesses at least one vNICs 310 for each of the virtual data center networks 502 that are used by the VNF.

An example configuration for illustrating the functionality of the technique is described with reference to FIGS. 3 to 5. The VLAN ω is configured with VLAN ID 1000 and an application Oₙ is connected to veth_{Y}. The application modules 302 are communicating via one or more TSMs 300 connected to the vNIC eth₀ of the VMs. It is possible to have two or more TSMs 300 inside any one of the VMs. E.g., the VM has two or more vNICs and a TSM is connected to each of the vNICs 310. Any application module 302 may be connected through one of the TSMs 310.

All application modules 302 and 312 connected to the same VLAN have stored IP addresses of the other application modules connected to same VLAN. Any static or dynamic address allocation method or protocol can be used over the Layer 2 overlay tunnel network for IP address allocation.

The signaling sequence 800 of FIG. 8 is described in the context of the application module Oₙ executed by the first VM 100 labeled N. The application module Oₙ sends a message to the application module O₁ on the second VM 110 labeled 1 using the tunnel 304.

In step 1 of the sequence 800, the application module Oₙ sends an IP message to application module O₁, using the IP address of application O₁ as the destination IP address. In step 2 of the sequence 800, the veth_{Y} to which application module Oₙ is connected sends a Layer 2 ARP broadcast message tagged with VLAN ID 1000 through the VM-internal tunnel 308 towards the TSM 300 for determining the MAC address of application module O₁. The VM-internal TE connected to the veth_{Y} encapsulates (or packs) the layer 2 message as payload into a transport protocol message, e.g. an IP message or and IP/User Datagram Protocol (UDP) message. The transport protocol message is forwarded through the VM-internal tunnel to the TE inside the TSM 300, which extracts (or unpacks) the L2 message.

In step 3 of the sequence 800, the Layer 2 message extracted from the tunnel 308 is forwarded to the L2CF responsible for handling VLAN ID 1000 inside the TSM 300 and the corresponding port of the L2CF learns the MAC address of the veth_{Y} used by application Oₙ and stores the port in its ARP table. Application Oₙ is identified by the MAC address of veth_{Y} on the layer 2 network.

In step 4 of the sequence 800, the L2CF responsible for handling VLAN ID 1000 inside the TSM 300 forwards the ARP message to each port connected to an external tunnel 304. In this way the L2 ARP message will reach all other (i.e., second) VMs 110 inside the VNF through the overlay tunnel network.

In step 5 of the sequence 800, the messages are sent out through the tunnels 304. Due to the tunneling mechanism brought about by the method 200, the Layer 2 ARP message tagged with VLAN ID 1000 is encapsulated (or packed) in a transport protocol data packet, e.g., an IP message or IP/UDP message, and the transport protocol message is sent out through the vNIC 310, to which the instance of the TSM 300 is connected, towards all known TEs (of the second VMs 110) inside the VNF according to the tunnel endpoint addresses.

In step 6 of the sequence 800, the TEs on the second VMs 110 extract (or unpack) the Layer 2 ARP message tagged with VLAN ID 1000 from the transport protocol message. The extracted message is forwarded to the instance of the TSM connected to the vNIC eth0 at which the tunneled message has arrived. The L2CF inside the TSM instance learn the MAC address of the application module Oₙ, which is the same as the MAC address of the veth_{Y} to which the application module Oₙ is connected, and stores this MAC address in the ARP table of the port connected to the tunnel 304 through which the transport protocol message has arrived.

In step 7 of the signaling sequence 800, the L2CF inside the TSM instance forwards the Layer 2 ARP message tagged with VLAN ID 1000 towards the TE of the internal tunnel inside the TSM. In step 8, the Layer 2 ARP message tagged with VLAN ID 1000 is packed into a transport protocol message (e.g. IP or IP/UDP) and sent through the internal tunnel to the other TE located for example in the (Linux) kernel of the second VM 110.

In step 9 of the signaling sequence 800, after extracting (or unpacking) at the other TE, the Layer 2 ARP message tagged with VLAN ID 1000 arrives to the veth_{Z} terminating the virtual link. The veth_{Z} connected to application module O₁ recognize its IP address and answers the Layer 2 ARP message indicating its MAC address. The veth_{Z} also store the MAC address corresponding to application module Oₙ in its ARP table. The answer message will be tagged with a VLAN tag carrying VLAN ID 1000.

In step 10 of the signaling sequence 800, the answer message follows the same path back as the path along which the request had been transported. Hence, the MAC address of the veth_{Z} corresponding to application module O₁ is determined and stored in the ARP tables placed along the path. In this way, both Ethernet interfaces terminating the Layer 2 logical link 305 between the application modules Oₙ and O₁ determine the MAC addresses of each other.

In step 11 of the signaling sequence 800, using the stored MAC address of the destination application module, the veth_{Y} connected to source application module Oₙ encapsulates the IP message received from the application module Oₙ in step 1 into a Layer 2 message and sends the Layer 2 message tagged with VLAN ID 1000 towards the destination application module O₁ through the internal tunnel 308. The Layer 2 message is encapsulated into a transport protocol message, e.g. an IP or IP/UDP message, and forwarded through the internal tunnel towards the TSM instance. The tunneled Layer 2 message follows the same path as the Layer 2 ARP message to the destination application module O₁.

In step 12 of the signaling sequence 800, the veth_{Z} extracts the IP payload from the VLAN tagged L2 message and forwards the extracted message to application module O₁. The term “datagram” may encompass any extracted payload.

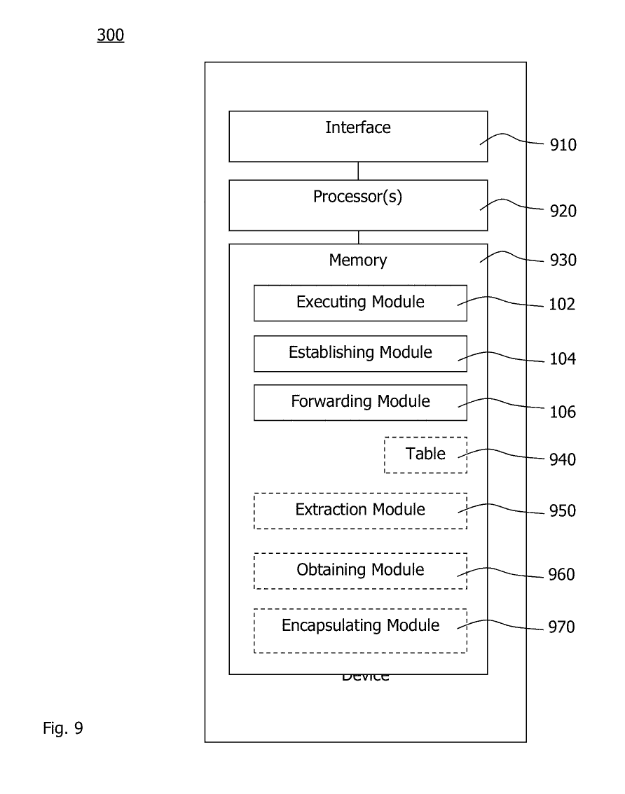

FIG. 9 depicts exemplary structures of a device 300 for exchanging datagrams between application modules executed by machines connected to a telecommunications network, comprising a processor 920 and a memory 930. Said memory 930 contains instructions executable by said processor 920, whereby said device 300 is operative to execute (or control executing) one or more application modules, each of which is associated with an application module address and configured to exchange the datagrams using the associated application module address. Said device 300 is further operative to establish a plurality of tunnels between a first machine and a plurality of second machines different from the first machine, each of the tunnels being associated with a tunnel endpoint address for one of the second machines. The device 300 is further operative to forward the datagrams between the application modules and the tunnels depending on the application module address. The device may be associated (e.g., collocated) with the first machine. The device 300 may further comprise an interface 910, which may be adapted to exchange said datagrams.

In a further embodiment, the device 300 is further configured to maintain a table 940 in the memory 930, which is depicted as an optional feature with dotted lines. The table 940 associates each of the application module addresses with one of the tunnel endpoint addresses. The datagrams are forwarded by querying the table based on the application module address, e.g. via the interface 910.

In a further embodiment, the device 300 may be operative to receive data packets through the tunnels, the received data packets including a source address field indicative of the tunnel endpoint address. Furthermore, the device 300 may comprise in its memory 930 instructions executable by said processor 920, depicted as an optional extraction module 950 with dotted lines, whereby said device 300 is operative to extract the datagrams from the received data packets. The extracted datagrams may include a destination address field indicative of the application module address. The device may be further operative to send the extracted datagrams to the application module 302 specified by the application module address, e.g. via the interface 910.

In a further embodiment, the device 300 may be operative to obtain the datagrams from the application modules 302 via an obtaining module 960, which is depicted as an optional module in dotted lines. The obtained datagrams include a source address field indicative of the application module address. The device 300 may further be operative to encapsulate the obtained datagrams in data packets via an encapsulating module 970, depicted as an optional module in dotted lines. The data packets may include a destination address field indicative of the tunnel endpoint address depending on the application module address. The device may further be operative to send the data packets through the tunnel specified by the tunnel endpoint address, e.g. via the interface 910.

It is to be understood that the structures as illustrated in FIG. 9 are merely schematic and that the device 300 may actually include further components which, for the sake of clarity, have not been illustrated, e.g., further interfaces or processors. Also, it is to be understood that the memory 930 may include further types of program code modules, which have not been illustrated. According to some embodiments, also a computer program may be provided for implementing functionalities of the device, e.g., in the form of a physical medium storing the program code and/or other data to be stored in the memory 930 or by making the program code available for download or by streaming.

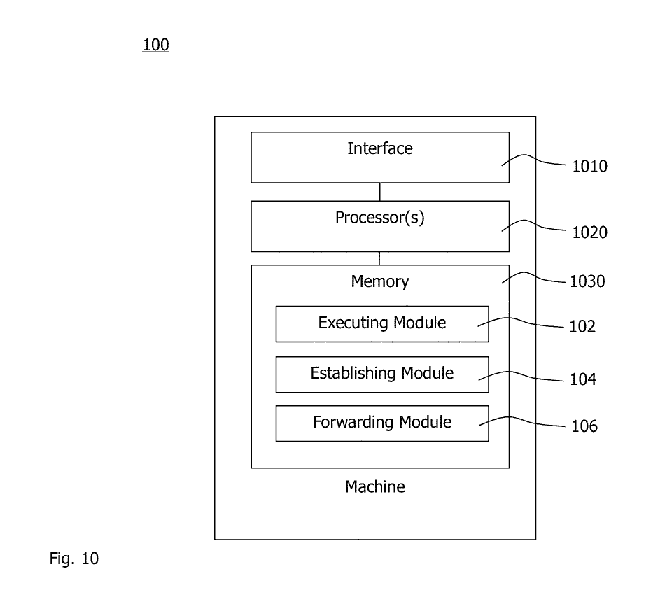

FIG. 10 depicts exemplary structures of a first machine 100 for exchanging datagrams between application modules 302. The first machine 100 is connected or connectable to a telecommunications network. The first machine 100 comprises a processor 1020 and a memory 1030. Said memory 1030 containing instructions executable by said processor 1020, whereby said first machine 100 is operative to execute one or more application modules 302, each of which is associated with an application module address and configured to exchange the datagrams using the associated application module address. The first machine 100 is further operative to establish a plurality of tunnels 304 between the first machine 100 and a plurality of second machines 110 different from the first machine 100, each of the tunnels 304 being associated with a tunnel endpoint address for one of the second machines 110. The first machine 100 is further operative to forward the datagrams between the application modules 302 and the tunnels 304 depending on the application module address. The first machine 100 may further comprise an interface 1010, which may be adapted to forward said datagrams to a plurality of second machines 110.

It is to be understood that the structures as illustrated in FIG. 10 are merely schematic and that the first machine may actually include further components which, for the sake of clarity, have not been illustrated, e.g., further interfaces or processors. Also, it is to be understood that the memory 1030 may include further types of program code modules, which have not been illustrated. According to some embodiments, also a computer program may be provided for implementing functionalities of the first machine, e.g., in the form of a physical medium storing the program code and/or other data to be stored in the memory 1030 or by making the program code available for download or by streaming.

As has become apparent from above description of exemplary embodiments, the technique allows using a relatively simple and/or common structure of IP networks for achieving a strict isolation of different communication channels carrying different traffic types or serving different operators, e.g., as is required for telecommunications networks and/or networks inside of network nodes.

The isolation in telecommunications networks is achievable by implementing the technique, e.g., with virtualization of Local Area Networks (LANs) using Virtual LANs (VLANs), e.g., conforming to the IEEE 802.1Q standard. As an example, inside an MSC node, many VLANs are used to isolate internal networks. This can be done for isolating Operation and Maintenance (O&M) signaling that controls hardware blades forming the node from other traffic, for isolating internal traffic between the blades from external traffic, for isolating external traffic channels from each other when these are used by different operators, for isolating charging output channels towards different operators, etc.

The technique may allow harnessing prevailing principles in IP tunneling, e.g., encapsulation of a tunneled protocol message as payload of an IP or IP/UDP message or data packet. Conventionally, IP networking elements responsible for sending, routing and receiving the carrier IP or IP/UDP message have no possibility to look inside the tunneled protocol message. Because of this limitation, the routing of a carrier IP message based on the addressing information or VLAN tag included in the tunneled message is not possible with existing standard IP networking components.

The tunnels may be established using a point-to-point tunneling protocols that is able to transfer complete layer 2 messages including VLAN tags. Examples for such protocols include the Generic Routing Encapsulation (GRE) protocol or the Layer 2 Tunneling Protocol (L2TP). The technique may be combined with multipoint tunneling protocols, for example a standardized Dynamic Multipoint Virtual Private Network (DMVPN) protocol using the GRE protocol and a Next Hop Resolution Protocol (NHRP) according to RFC 2332; standardized Point-to-Multipoint (P2MP) and Multipoint-to-Multipoint (MP2MP) protocols for Label Switched Paths (LSPs) in Multi-Protocol Label Switching (MPLS), a Linux-based multicast GRE-tunneling forming a virtual Ethernet-like broadcast network, etc.

The technique may be implemented to overcome limitations of above protocols as to transferring complete Layer 2 messages including VLAN tags.

When virtualizing a complex network node to deploy a Virtual Network Function (VNF) in a data center, the network functionality of each application module of the network node may be virtualized and placed inside a Virtual Machine (VM). The VMs can be interconnected via one or more internal networks inside the data center. Each virtual Network Interface Card (vNIC) of a VM can be attached to an internal network.

The connection of the vNIC to an internal network is conventionally achieved via a port of a virtual switch of the data center. The technique may be implemented to overcome any of the following limitations. The virtual switch port may be a type access port allowing only untagged traffic, which does not permit the usage of VLANs through the vNICs. The number of vNICs per VM may be limited below the number of traffic types which have to be isolated from each other. The operator of the VNF (also called a tenant) may not want to disclose parts of the internal traffic to an administrator of the data center. The communication between the modules of the node (e.g., VMs inside the VNF) may use a Maximum Transmission Unit (MTU) sizes for some dedicated traffic type, which may not match the available MTU size of the network in the data center.

Furthermore, there may be two types of virtual switch ports: access ports and trunk ports. Through access ports, only untagged traffic may be permitted which later on is tagged by the virtual switch itself. The tag is identifying the tenant using the port during the communication between parts of the virtual switch deployed on different blades. Trunk ports are allowing tagged traffic from the vNICs. Supporting only trunk ports will limit the area of deployment of a VNF. The technique may be implemented to avoid preparing VNFs to work with access ports. Thus, VNFs can be largely deployed.

The technique may be implemented to avoid internal network redesigns (e.g., during the virtualization of a network node) in a given data center.

As compared to existing multipoint tunneling solutions, the technique may be implemented to avoid a large number of control messages necessary for operating the multipoint tunneling solutions, which are diminishing the available networking capacity for the VNF. Moreover, the technique may be implemented to eliminate the need for an intermediation network node, a server or special router, which knows all registered participants in the overlay network created by multipoint tunneling.

At least some embodiments of the technique may allow focusing on transposing existing functionality from the (e.g., hardware) modules to the VMs. The internal networking solution inside the VNF can be kept unchanged.

The complexity of the internal networking solution may be kept inside the VNF, since the tunneling mechanism is part of the VMs and the deployment of the VNF is independent of the data center.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1.-46. (canceled)

47. A method of exchanging datagrams between application modules executed by virtual machines connected to a telecommunications network, wherein the virtual machines are executed on one or more physical machines, the method comprising the following steps performed or triggered by a first virtual machine of the virtual machines:
executing one or more application modules, each of which is associated with an application module address and configured to exchange the datagrams using the associated application module address;
establishing a plurality of tunnels between the first virtual machine and a plurality of second virtual machines different from the first virtual machine, each of the tunnels being associated with a tunnel endpoint address for one of the second virtual machines; and
forwarding the datagrams between the application modules and the tunnels depending on the application module address.

48. The method of claim 47, further comprising:
maintaining a table, the table associating each of the application module addresses with one of the tunnel endpoint addresses,
wherein the datagrams are forwarded by querying the table based on the application module address.

49. The method of claim 47, wherein the forwarding includes transforming the datagrams between a first protocol used by the one or more application modules and a second protocol used by the plurality of tunnels.

50. The method of claim 49, wherein the second protocol is a tunneling protocol.

51. The method of claim 50, wherein those datagrams that are forwarded towards the tunnels are encapsulated according to the tunneling protocol.

52. The method of claim 50, wherein those datagrams that are forwarded towards the one or more application modules are extracted according to the tunneling protocol.

53. The method of claim 47, wherein the application module address and the tunnel endpoint address relate to different layers of a protocol stack used for the exchanging of the datagrams.

54. The method of claim 47, wherein the application module address includes an L2 address, and/or wherein the tunnel endpoint address includes an L3 address.

55. The method of claim 47, wherein each of the application modules is associated to a virtual Ethernet port of the first virtual machine.

56. The method of claim 55, wherein the virtual Ethernet ports are implemented in a kernel of an operating system of the first machine.

57. The method of claim 47, wherein at least one of the first machine and the second machines is located in a data center, and the telecommunications network includes a data network within the data center.

58. The method of claim 47, wherein the forwarding includes receiving or sending data packets through the tunnels.

59. The method of claim 47, wherein the forwarding includes:
receiving data packets through the tunnels, the received data packets including a source address field indicative of the tunnel endpoint address;
extracting the datagrams from the received data packets, the extracted datagrams including a destination address field indicative of the application module address; and
sending the extracted datagrams to the application module specified by the application module address.

60. The method of claim 47, wherein the forwarding includes:
obtaining the datagrams from the application modules, the obtained datagrams including a source address field indicative of the application module address;
encapsulating the obtained datagrams in data packets including a destination address field indicative of the tunnel endpoint address depending on the application module address; and
sending the data packets through the tunnel specified by the tunnel endpoint address.

61. The method of claim 58, wherein a payload of the data packets includes the datagrams.

62. The method of claim 47, wherein the forwarding includes:
forwarding a first datagram from one of the application modules to one of the tunnels; and
forwarding a second datagram from the one tunnel to the one application module in response to the first datagram.

63. An electronic device for exchanging datagrams between application modules executed by virtual machines connected to a telecommunications network, wherein the virtual machines are executed on one or more physical machines, the electronic device being configured to perform or trigger performing the following steps performed by a first virtual machine of the virtual machines:
executing one or more application modules, each of which is associated with an application module address and configured to exchange the datagrams using the associated application module address;
establishing a plurality of tunnels between the first virtual machine and a plurality of second virtual machines different from the first virtual machine, each of the tunnels being associated with a tunnel endpoint address for one of the second virtual machines; and
forwarding the datagrams between the application modules and the tunnels depending on the application module address.

64. A virtual machine for exchanging datagrams between application modules, the virtual machine being connected or connectable to a telecommunications network, wherein the virtual machine is executed on one or more physical electronic machines, comprising:
an executing module for executing one or more application modules, each of which is associated with an application module address and configured to exchange the datagrams using the associated application module address;
an establishing module for establishing a plurality of tunnels between the first virtual machine and a plurality of second virtual machines different from the first virtual machine, each of the tunnels being associated with a tunnel endpoint address for one of the second machines; and
a forwarding module for forwarding the datagrams between the application modules and the tunnels depending on the application module address.
